(19) United States
(12) Patent Application Publication
(10) Pub. No.: US 2025/0387792 A1
(43) Pub. Date: Dec. 25, 2025

(54) COMPOSITIONS AND METHODS FOR FROTH MODIFICATION

(71) Applicant: Ecolab USA Inc., St. Paul, MN (US)

(72) Inventors: Xiaojin Harry Li, Bartlett, IL (US); Jianjun Liu, Aurora, IL (US); Yu Xiong, Charlotte, NC (US)

(21) Appl. No.: 19/204,888

(22) Filed: May 12, 2025

Related U.S. Application Data
(60) Provisional application No. 63/646,029, filed on May 13, 2024.

(51) Int. Cl. B03D 1/008

(52) U.S. Cl. CPC B03D 1/008; B03D 2201/007; B03D 2201/02; B03D 2201/06

(57) ABSTRACT

Modifier compositions, improved sparge compositions for froth flotation separation containing the modifier compositions, and improved methods of froth flotation using the modifier compositions have been developed, as well as kits including the modifier composition for industrial use. The modifier compositions obtain both improved yield and a higher grade of a targeted mineral product in froth flotation of one or more phosphate, lithium, and/or iron ores, while avoiding excess foam formation during the flotation.

### BACKGROUND

Many minerals and other materials are obtained from mining and other resource recovery operations as an intimate mixture that is difficult to separate into its constituents. For example, ores as mined are often multimineralic, and contain at least one desired component, a beneficiary, and one or more other less valuable and/or desirable materials, a gangue.

In a beneficiation process, two or more materials that coexist in a mixture are separated from each other to obtain a beneficiary in a more concentrated form than that which existed in the mixture. One form of beneficiation is froth flotation separation.

In froth flotation separation of a mineral ore, the ore is finely ground (comminuted) to form a comminuted ore in the form of a particulate. The comminuted ore is slurried in a liquid medium, typically water, to make a slurry that is a sparge composition. Other components that assist in the separation of beneficiary from gangue can be included in the sparge composition, components such as collectors, modifiers, depressants, frothers (frothing agents), and/or activators.

In a process known as sparging, a gas, typically air, is bubbled through the sparge composition, and a froth forms at the surface of the sparge composition. During sparging, some materials from the ore such as targeted particles are carried up with the gas bubbles (i.e. floated) and concentrate in the froth, whereas other materials concentrate in the body of the liquid, the underflow.

The role of a collector is to assist the flotation of targeted particles in the sparge composition. The role of a depressant is to hinder or prevent the flotation of untargeted particles in the sparge composition.

When the sparge composition is sparged, bubbles associate with the more hydrophobic particles present in the ore, and rise up out of the slurry; and the associated bubble-particle composite forms a layer, referred to as a “froth” or “overflow”. The overflow is accordingly partitioned from and situated above an underflow. The underflow includes ore solids that are less hydrophobic than the particles that form the froth. The overflow may be deposited on a launder. The less hydrophobic material remains behind in the underflow, thereby accomplishing the froth flotation separation.

Two common forms of flotation separation processes are direct flotation and reverse flotation. In direct flotation processes the froth comprises the beneficiary or concentrate, while in reverse flotation processes the froth comprises gangue or tailings. The object of the flotation in both forms of froth flotation is to separate and recover as much as possible of the beneficiary from the particulate material in as high a concentration of that beneficiary as possible. In froth flotation, a sparge composition is sparged to form a froth layer and an underflow. In a direct froth flotation, the froth layer comprises a concentrated beneficiary (a concentrate), and the underflow comprises tailings (concentrated gangue). In reverse froth flotation, the froth layer comprises tailings and the underflow comprises a concentrated beneficiary. In direct froth flotation, the froth can comprise more beneficiary than gangue, and the tailings can comprise more gangue than beneficiary. In reverse froth flotation, the froth can comprise more gangue than beneficiary and the tailings can comprise more beneficiary than gangue.

Froth flotation separation can be used to separate solids from solids (such as the constituents of mine ore), and liquids or semi-solids from solids (such as the separation of bitumen from oil sands).

A prerequisite for flotation separation is the liberation of particles. For flotation of mineral ores, therefore, comminuting (grinding the solids up by such techniques as dry-grinding, wet-grinding, and the like) is required to liberate minerals. Extensive grinding or comminution can result in better liberation of particles for the separation of beneficiary and gangue in a froth flotation process.

Although the object of froth flotation is to separate and recover as much as possible of the beneficiary in as high a concentration as possible, in such processes there is a compromise between purity of concentrate and yield of the beneficiary. Adjustment of froth flotation conditions and/or materials can produce an improvement of purity at the expense of yield or visa-versa. Further, changes to the chemistry or cell size used for the froth flotation process can cause excessive frothing during the froth flotation process, which has been observed to correlate to reduced grade and/or recovery (yield) of beneficiary, in addition to froth handling issues.

Further, over the past few decades, the need to process more minerals while lowering capital costs has led to an increase in the size of flotation cells, for example 0.03 m³ to 1000 m³. This increase has created new challenges in the operation of industrial flotation cells, particularly in terms of froth removal, because the distance the froth must travel increases with an increase in the flotation cell diameter, which negatively impacts recovery.

Accordingly, there is an ongoing need to provide improved compositions and methods of froth flotation that can be implemented in existing froth flotation installations for separation of beneficiaries from ores. It would be an advantage to provide improved methods and materials therefor for obtaining better yields and better purity of beneficiaries. It would be an advantage to provide improved methods and/or compositions for froth flotation which do not cause excessive frothing during the froth flotation process accompanied by reduced grade and/or recovery (yield) of beneficiary and froth handling issues.

### SUMMARY

Disclosed in first embodiments herein are modifier compositions comprising, consisting essentially of, or consisting of a mixture of one or more fatty acid triglycerides with one or more alkoxylated fatty alcohols. In some first embodiments, the weight proportion of the one or more fatty acid triglycerides to the one or more alkoxylated fatty alcohols in the mixture is between 100:1 and 1:100.

In any one or more modifier compositions of first embodiments, at least one of the one or more alkoxylated fatty alcohols has a structure according to the formula

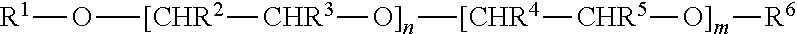

wherein
R¹ is a linear, branched, or alicyclic C6-C30 saturated or unsaturated moiety,
R², R³, R⁴, R⁵ and R⁶ are independently selected from H or a C1-C5 linear or branched alkyl moiety,
n is 0 or an integer between 1 and 100,
m is 0 or an integer between 1 and 100, and
the sum of n+m is at least 2.

In any one or more modifier compositions of first embodiments, the one or more alkoxylated fatty alcohols comprises, consists essentially of, or consists of a first alkoxylated fatty alcohol comprising R¹ that is a linear or branched C10-C20 moiety; and a second alkoxylated fatty alcohol comprising R¹ that is a linear or branched C6-C14 moiety. In some such embodiments, the first alkoxylated fatty alcohol comprises R² R³, and R⁴ each of which is H, R⁵ that is CH₃, n that is between 1 and 35, and m that is between 1 and 35; and the second alkoxylated fatty alcohol comprises R² R³, and R⁴ each of which is H, R⁵ that is CH₃, n that is between 1 and 35, and m that is between 1 and 35. In embodiments, the weight proportion of the first alkoxylated fatty alcohol to the second alkoxylated fatty alcohol in the mixture is 100:1 to 1:100.

In any one or more modifier compositions of first embodiments, each of the one or more fatty acid triglycerides independently has a structure according to the formula

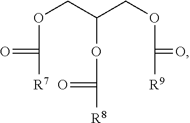

wherein R⁷, R⁸, and R⁹ are independently selected from saturated or unsaturated C6-C30 linear, branched, or alicyclic moieties. In any one or more modifier compositions of first embodiments, one or more of R⁷, R⁸, and R⁹ are C10-C20 moieties. In any one or more modifier compositions of first embodiments, one or more of R⁷, R⁸, and R⁹ are linear. In any one or more modifier compositions of first embodiments, each of R⁷, R⁸, and R⁹ are linear. In any one or more modifier compositions of first embodiments, one or more of R⁷, R⁸, and R⁹ are unsaturated. In any one or more modifier compositions of first embodiments, each of R⁷, R⁸, and R⁹ are unsaturated. In any one or more modifier compositions of first embodiments, one or more of R⁷, R⁸, and R⁹ are monounsaturated. In any one or more modifier compositions of first embodiments, one or more of R⁷, R⁸, and R⁹ include two or three unsaturated moieties.

In any one or more modifier compositions of first embodiments, at least one of the one or more fatty acid triglycerides is derived from a plant source. Suitable plant sources include whole plants, seeds, stems, flowers, roots, or two or more thereof from cotton, flax, grape, hemp, safflower, olive, palm, peanut, rice, avocado, canola, coconut, corn, sesame, soybean, sunflower, walnut, or any combination thereof.

In any one or more modifier compositions of first embodiments, the modifier composition further includes a solvent. In any one or more modifier compositions of first embodiments, the solvent comprises, consists essentially of, or consists of a hydrocarbon or mixture thereof. In any one or more modifier compositions of first embodiments, the solvent comprises, consists essentially of, or consists of water. In any one or more modifier compositions of first embodiments, the mixture of one or more fatty acid triglycerides with one or more alkoxylated fatty alcohols is present at 0.1 wt % to 99.9 wt % in a solvent.

Disclosed in second embodiments herein are sparge compositions comprising, consisting essentially of, or consisting of a mixture of: a medium comprising water; a mineral ore comprising a beneficiary and a gangue; a collector; and a modifier composition of any of first embodiments. In any one or more sparge compositions of second embodiments, the water is fresh water or sea water. In any one or more sparge compositions of second embodiments, the mineral ore is a phosphate ore, a lithium ore, or an iron ore. In any one or more sparge compositions of second embodiments, the phosphate ore comprises an apatite, such as an apatite is selected from the group consisting of fluorapatite, hydroxyapatite, chlorapatite, or any combination thereof. In any one or more sparge compositions of second embodiments, the gangue comprises calcite, dolomite, a silicate, silica, a seashell or seashell portion, or any combination thereof. In any one or more sparge compositions of second embodiments, the weight proportion of the mineral ore to the modifier composition of any of first embodiments in the sparge composition is about 1000:1 to 2:1.

In any one or more sparge compositions of second embodiments, the sparge composition further includes a pH adjustment agent, such as an acid selected from phosphoric acid, sulfuric acid, hydrochloric acid, acetic acid, citric acid, a polymeric acid, or any combination thereof; or a base selected from sodium carbonate, potassium carbonate, sodium bicarbonate, potassium bicarbonate, sodium hydroxide, potassium hydroxide, or any combination thereof. Accordingly, in some sparge compositions of second embodiments, the sparge composition includes, is present at, or is adjusted to have a pH between 2.5 and 7; in other second embodiments, the sparge composition includes, is present at, or is adjusted to have a pH between 7 and 12.

In any one or more sparge compositions of second embodiments, the collector comprises, consists essentially of, or consists of one or more sulfonated fatty acids, one or more sulfonated fatty acid salts, or any combination thereof. In any one or more sparge compositions of second embodiments, the collector comprises, consists essentially of, or consists of a sulfonated oleic acid, a sulfonated oleic acid salt, sulfonated linoleic acid, a sulfonated linoleic acid salt, a sulfonated linolenic acid, a sulfonated linolenic acid salt, a sulfonated ricinoleic acid, a sulfonated ricinoleic acid salt, a sulfonated palmitoleic acid, a sulfonated palmitoleic acid salt, a sulfonated 11-eicosenoic acid, a sulfonated 11-eicosenoic acid salt, a sulfonated erucic acid, a sulfonated erucic acid salt, a sulfonated nervonic acid, a sulfonated nervonic acid salt, or any combination thereof.

In any one or more sparge compositions of second embodiments, the sparge composition further includes a beneficiating agent. In any one or more sparge compositions of second embodiments, the beneficiating agent comprises, consists essentially of, or consists of one or more hydroxy fatty acids, one or more hydroxy fatty acid salts, or any combination thereof. In any one or more sparge compositions of second embodiments, the beneficiating agent comprises, consists essentially of, or consists of ricinoleic acid, a salt of ricinoleic acid, 12-hydroxystearic acid, a salt of 12-hydroxystearic acid, 9,10-dihydroxyoctadecanoic acid, a salt of 9,10-dihydroxyoctadecanoic acid, 9,10,18-trihydroxyoctadecanoic acid, a salt of 9,10,18-trihydroxyoctadecanoic acid, lesquerolic acid, a salt of lesquerolic acid, 15-hydroxyhexadecanoic acid, a salt of 15-hydroxyhexadecanoic acid, isoricinoleic acid, a salt of isoricinoleic acid, densipolic acid, a salt of densipolic acid, 14-hydroxy-eicosa-cis-11-cis-17-dienoic acid, a salt of 14-hydroxy-eicosa-cis-11-cis-17-dienoic acid, 2-hydroxyoleic acid, a salt of 2-hydroxyoleic acid, 2-hydroxylinoleic acid, a salt of 2-hydroxylinoleic acid, 18-hydroxystearic acid, a salt of 18-hydroxylinoleic acid, 15-hydroxylinoleic acid, a salt of 15-hydroxylinoleic acid, or any combination thereof.

In any one or more sparge compositions of second embodiments, the sparge composition further includes one or more emulsifying surfactants, one or more additional collectors, one or more depressants, one or more activators, one or more frothing agents, or any combination thereof.

Disclosed in third embodiments herein are methods of froth flotation comprising, consisting essentially of, or consisting of combining a medium comprising water, a mineral ore comprising a beneficiary and a gangue, and a collector to form an ore slurry; adding a modifier composition of any of first embodiments to the ore slurry to form a sparge composition of second embodiments, and sparging the sparge composition to yield a sparged slurry comprising an overflow and an underflow. In any one or more methods of third embodiments, the sparging is carried out in a lab scale flotation cell. In any one or more methods of third embodiments, the method further includes collecting the overflow, collecting the underflow, or collecting both the overflow and the underflow.

In any one or more methods of third embodiments, the mineral ore is a phosphate ore, a lithium ore, or an iron ore. In any one or more methods of third embodiments where the mineral ore is a phosphate ore, the underflow includes a phosphate beneficiary, and the overflow includes a gangue. In any one or more methods of third embodiments, the gangue comprises one or more of a calcite, a dolomite, or a silica. In any one or more methods of third embodiments, the method further includes grinding the mineral ore prior to the combining.

In any one or more methods of third embodiments, the method further includes combining a pH adjustment agent with the ore slurry, or with the sparge composition prior to the sparging. In any one or more methods of third embodiments, the pH adjustment agent is selected from any one or more of the pH adjustment agents of second embodiments. Accordingly, in some methods of third embodiments, the method further includes combining a pH adjustment agent with the ore slurry, or with the sparge composition prior to the sparging, in an amount sufficient to obtain a pH of about 2.5 to about 7; while in some other third embodiments, the method further includes combining a pH adjustment agent with the ore slurry, or with the sparge composition prior to the sparging, in an amount sufficient to obtain a pH of about 7 to about 12.

In any one or more methods of third embodiments, the collector is selected from any one or more of the collectors of second embodiments.

In any one or more methods of third embodiments, the method further includes adding a beneficiation agent to the mineral ore, to the medium, to the collector, or to the ore slurry, wherein the beneficiation agent is selected from any one or more of the beneficiation agents of second embodiments. In any one or more methods of third embodiments, the beneficiating agent is combined with one or more components of the ore slurry, or is combined with the ore slurry, prior to adding the modifier to the ore slurry to form a sparge composition in accordance with second embodiments herein. In any one or more methods of third embodiments, the collector is mixed with the beneficiation agent, and the collector-beneficiation mixture is then combined with the mineral ore and the medium to form the ore slurry.

In any one or more methods of third embodiments, adding the modifier composition to the ore slurry comprises, consists essentially of, or consists of admixing the modifier composition with a solvent, and adding the admixed modifier composition to the ore slurry. In some methods of third embodiments, the solvent comprises water and the admixed modifier composition includes 0.1 wt % to 99.9 wt % water, in some embodiments 0.1 wt % to 10 wt % water.

In any one or more methods of third embodiments, the method further includes adding one or more emulsifying surfactants, one or more additional collectors, one or more depressants, one or more activators, one or more frothing agents, or any combination thereof to one or more of: the medium, the mineral ore, the collector, the ore slurry, or the sparge composition.

Disclosed in fourth embodiments herein is the use of any one or more of the sparge compositions of second embodiments, which include a modifier composition in accordance with any one or more first embodiments herein, to refine a mineral ore using reverse froth flotation to provide a refined mineral ore.

Disclosed in fifth embodiments herein are froth flotation processing kits comprising, consisting essentially of, or consisting of a modifier composition of first embodiments, and a collector composition comprising, consisting essentially of, or consisting of one or more sulfonated fatty acids, one or more sulfonated fatty acid salts. In any one or more kits of fifth embodiments, the kit includes a modifier composition of first embodiments disposed within a first containment; and a collector composition disposed within a second containment. In any one or more kits of fifth embodiments, the modifier composition, the collector composition, or both the modifier composition and the collector composition further include a solvent. In any one or more kits of fifth embodiments, the solvent of the modifier composition is the same or different from the solvent of the collector composition.

In any one or more froth flotation processing kits of fifth embodiments, a kit further includes a beneficiation agent. In any one or more such fifth embodiments, the beneficiation agent is present in the kit as a mixture with the collector composition; or is disposed within a third containment. In embodiments where the beneficiation agent is provided in a third containment, the beneficiation agent optionally further includes a solvent, where the solvent may be the same or different from solvent of the modifier composition and/or the solvent of the collector composition.

### DETAILED DESCRIPTION

Although the present disclosure provides references to preferred embodiments, persons skilled in the art will recognize that changes may be made in form and detail without departing from the spirit and scope of the invention. Reference to various embodiments does not limit the scope of the claims attached hereto. Additionally, any examples set forth in this specification are not intended to be limiting and merely set forth some of the many possible embodiments for the appended claims.

### Definitions

Unless otherwise defined, all technical and scientific terms used herein have the same meaning as commonly understood by one of ordinary skill in the art. In case of conflict, the present document, including definitions, will control.

As used herein, the terms “comprise(s),” “include(s),” “having,” “has,” “can,” “contain(s),” and variants thereof are intended to be open-ended transitional phrases, terms, or words that do not preclude the possibility of additional acts or structures. The singular forms “a,” “and” and “the” include plural references unless the context clearly dictates otherwise. The present disclosure also contemplates other embodiments “comprising,” “consisting of” and “consisting essentially of,” the embodiments or elements presented herein, whether explicitly set forth or not.

As used herein, the term “optional” or “optionally” means that the subsequently described event or circumstance may but need not occur, and that the description includes instances where the event or circumstance occurs and instances in which it does not.

As used herein, the term “about” modifying, for example, the quantity of an ingredient in a composition, concentration, volume, process temperature, process time, yield, flow rate, pressure, and like values, and ranges thereof, employed in describing the embodiments of the disclosure, refers to variation in the numerical quantity that can occur, for example, through typical measuring and handling procedures used for making compounds, compositions, concentrates or use formulations; through inadvertent error in these procedures; through differences in the manufacture, source, or purity of starting materials or ingredients used to carry out the methods, and like proximate considerations. The term “about” also encompasses amounts that differ due to aging of a formulation with a particular initial concentration or mixture, and amounts that differ due to mixing or processing a formulation with a particular initial concentration or mixture. Where modified by the term “about” the claims appended hereto include equivalents to these quantities. Further, where “about” is employed to describe a range of values, for example “about 1 to 5” or “about 1 to about 5”, the recitation means “1 to 5” and “about 1 to about 5” and “1 to about 5” and “about 1 to 5” unless specifically limited by context.

As used herein, “ore” or “mineral ore” means a solid material of economic value that is obtained from a subterranean source by excavation, and also the refined or processed products of such solids. Excavation includes but is not limited to quarrying, open-cast mining, or pit mining. Ores include but are not limited to rocks, minerals, mineral aggregates, metal compounds including both elemental forms of metal and compounds including metal atoms, and any rank of coal (peat, lignite, sub-bituminous, bituminous, or anthracite).

As used herein, “beneficiary” refers to the one or more economically valuable products present in a mineral ore as-mined, and also as separated from a mineral ore by refining and/or processing. Accordingly, “beneficiary” herein refers to the mineral(s) present in a mineral ore that are partitioned from a gangue, or are desirably partitioned from a gangue using froth flotation; and are desirably further collected for further purification, thermochemical conversion, or some other process to enable its economic value to be exploited.

As used herein, “gangue” refers generally to materials of low or no commercial value that are present in a mineral ore as-mined, for example clay or feldspar; and also as separated from a beneficiary by refining and/or processing of a mineral ore, and also the materials of low or no commercial value desirably partitioned from the beneficiary in order to increase the yield and/or purity of the beneficiary that is collected. Accordingly, “gangue” refers to the one or more materials present in a mineral ore as-mined, that are partitioned from the beneficiary, or are desirably partitioned from the beneficiary using froth flotation.

As used herein, “comminute” means to mechanically reduce the size of a solid mass. Non-limiting examples of comminuting include pulverizing, milling, crushing, and grinding.

As used herein, “flotation” or “froth flotation” indicates a process in which a sparge composition is sparged to form a sparged composition, wherein the sparged composition includes an overflow and an underflow.

As used herein, “overflow” refers to the froth portion of a partitioned sparged composition, wherein “froth” refers to a plurality of bubbles present in a sparged composition during sparging, after sparging, or both during and after sparging and collected at or proximal to the liquid-gas interface. The bubbles are formed by sparging the sparge composition with a gas such as air.

As used herein, “underflow” refers to the non-froth portion of a partitioned sparged composition; and accordingly an underflow excludes or substantially excludes froth.

As used herein, a “collector” means a material or mixture of materials that increases adhesion or association of the targeted particles to bubbles of a gas.

As used herein, “solvent” means a compound or mixture of two or more compounds, wherein the compound or the mixture of compounds is liquid at a temperature between −30° C. and 100° C. at 1 atm.

As used herein, “salt” refers to the conjugate base of a carboxylic acid moiety or a sulfonic acid moiety. The term “salt” refers not only to full salts but also to half-salts and the like, further as specified or determined by context herein. In embodiments, the salts comprise cations selected from Na⁺, K⁺, NH₄⁺, and any combination thereof.

### DISCUSSION

Preferred methods and materials are described below, although methods and materials similar or equivalent to those described herein can be used in practice or testing of the present invention. All publications, patent applications, patents and other references mentioned herein are incorporated by reference in their entirety. The materials, methods, and examples disclosed herein are illustrative only and not intended to be limiting.

We have found that inclusion of a modifier composition comprising at least one hydroxy fatty acid and/or a salt thereof in a sparge composition comprising a comminuted phosphate ore and a sulfonated fatty acid composition unpredictably improves the purity and/or yield of phosphate beneficiary in reverse froth flotation of the sparge composition.

### First Embodiments

Disclosed in first embodiments herein are modifier compositions comprising, consisting essentially of, or consisting of a mixture of one or more fatty acid triglycerides with one or more alkoxylated fatty alcohols. In some first embodiments, the weight proportion of the one or more fatty acid triglycerides to the one or more alkoxylated fatty alcohols in the mixture is between 100:1 and 1:100, for example 90:1 to 1:100, or 80:1 to 1:100, or 70:1 to 1:100, or 60:1 to 1:100, or 50:1 to 1:100, or 40:1 to 1:100, or 30:1 to 1:100, or 20:1 to 1:100, or 10:1 to 1:100, or 1:1 to 1:100, or 100:1 to 1:90, or 100:1 to 1:80, or 100:1 to 1:70, or 100:1 to 1:60, or 100:1 to 1:50, or 100:1 to 1:40, or 100:1 to 1:30, or 100:1 to 1:20, or 100:1 to 1:10, or 100:1 to 1:1, or 10:1 to 1:10, or 2:1 to 1:1, or 1:1 to 1:2, or 5:1 to 1:1, or 1:1 to 1:5, or 10:1 to 1:1, or 1:1 to 1:10, or 10:1 to 1:10, or 20:1 to 1:1, or 1:1 to 20:1, or 20:1 to 1:20, or 50:1 to 1:1, or 1:1 to 50:1, or 50:1 to 1:50, or 100:1 to 1:1, or 1:1 to 1:100, or about 1:1, or about 1:2, or about 1:3, or about 1:4, or about 1:5, or about 1:6, or about 1:7, or about 1:8, or about 1:9, or about 1:10, or about 1:20, or about 1:30, or about 1:40, or about 1:50, or about 1:60, or about 1:70, or about 1:80, or about 1:90, or about 1:100, or about 2:1, or about 3:1, or about 4:1, or about 5:1, or about 6:1, or about 7:1, or about 8:1, or about 9:1, or about 10:1, or about 20:1, or about 30:1, or about 40:1, or about 50:1, or about 60:1, or about 70:1, or about 80:1, or about 90:1, or about 100:1 by weight.

In first embodiments, at least one of the one or more alkoxylated fatty alcohols has a structure according to the formula (1),

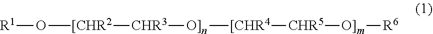

wherein R¹ is a linear, branched, or alicyclic C6-C30 saturated or unsaturated moiety, each R², R³, R⁴, R⁵ and R⁶ is independently selected from H or a C1-C5 linear or branched alkyl moiety, n is 0 or an integer between 1 and 100, m is 0 or an integer between 1 and 100, and the sum of n+m is at least 2. In any one or more embodiments of the alkoxylated fatty alcohol of formula (1), R¹ includes 6-30 carbons, for example 8-30 carbons, 10-30 carbons, 10-26 carbons, 10-22 carbons, 6-20 carbons, 8-20 carbons, or 10-20 carbons. In any one or more embodiments of the alkoxylated fatty alcohol of formula (1), R¹ is linear. In any one or more embodiments of the alkoxylated fatty alcohol of formula (1), R¹ is branched. In any one or more embodiments of the alkoxylated fatty alcohol of formula (1), R¹ includes one or more unsaturated moieties. In any one or more embodiments of the alkoxylated fatty alcohol of formula (1), m and n are each at least 1; each of R² R³, and R⁴ is H; and R⁵ is CH₃. In any one or more embodiments of the alkoxylated fatty alcohol of formula (1), m is 0 and R² and R³ are both H. In any one or more embodiments of the alkoxylated fatty alcohol of formula (1), R² and R³ are both H; n is a number between 1 and 35, or between 3 and 30, or between 3 and 20, or between 3 and 15; and m is a number between 1 and 35, or between 1 and 20, or between 1 and 15, or between 3 and 10. In any one or more embodiments of the alkoxylated fatty alcohol of formula (1), R⁶ is H or CH₃.

In some first embodiments, the one or more alkoxylated fatty alcohols comprises, consists essentially of, or consists of a first alkoxylated fatty alcohol comprising R¹ that is a linear or branched C16-C20 moiety; and a second alkoxylated fatty alcohol comprising R¹ that is a linear or branched C6-C14 moiety. In some such embodiments, the first alkoxylated fatty alcohol comprises R² R³, and R⁴ each of which is H, R⁵ that is CH₃, n that is between 1 and 35, and m that is between 1 and 35; and the second alkoxylated fatty alcohol comprises R² R³, and R⁴ each of which is H, R⁵ that is CH₃, n that is between 1 and 35 and m that is between 1 and 35. In any one or more such embodiments, n and m of each of the first and second alkoxylated fatty alcohols are independently between 1 and 5, between 5 and 10, between 10 and 15, between 15 and 20, between 20 and 25, between 25 and 30, or between 30 and 35; or n and m of each of the first and second alkoxylated fatty alcohols are independently 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, or 35. In embodiments, the weight proportion of the first alkoxylated fatty alcohol to the second alkoxylated fatty alcohol in the mixture is 100:1 to 1:100, for example for example 90:1 to 1:100, or 80:1 to 1:100, or 70:1 to 1:100, or 60:1 to 1:100, or 50:1 to 1:100, or 40:1 to 1:100, or 30:1 to 1:100, or 20:1 to 1:100, or 10:1 to 1:100, or 1:1 to 1:100, or 100:1 to 1:90, or 100:1 to 1:80, or 100:1 to 1:70, or 100:1 to 1:60, or 100:1 to 1:50, or 100:1 to 1:40, or 100:1 to 1:30, or 100:1 to 1:20, or 100:1 to 1:10, or 100:1 to 1:1, or 10:1 to 1:10, or 2:1 to 1:1, or 1:1 to 1:2, or 5:1 to 1:1, or 1:1 to 1:5, or 10:1 to 1:1, or 1:1 to 1:10, or 10:1 to 1:10, or 20:1 to 1:1, or 1:1 to 20:1, or 20:1 to 1:20, or 50:1 to 1:1, or 1:1 to 50:1, or 50:1 to 1:50, or 100:1 to 1:1, or 1:1 to 1:100, or about 1:1, or about 1:2, or about 1:3, or about 1:4, or about 1:5, or about 1:6, or about 1:7, or about 1:8, or about 1:9, or about 1:10, or about 1:20, or about 1:30, or about 1:40, or about 1:50, or about 1:60, or about 1:70, or about 1:80, or about 1:90, or about 1:100, or about 2:1, or about 3:1, or about 4:1, or about 5:1, or about 6:1, or about 7:1, or about 8:1, or about 9:1, or about 10:1, or about 20:1, or about 30:1, or about 40:1, or about 50:1, or about 60:1, or about 70:1, or about 80:1, or about 90:1, or about 100:1.

In first embodiments, each of the one or more fatty acid triglycerides independently has a structure according to formula (2),

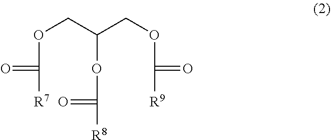

wherein R⁷, R⁸, and R⁹ are independently selected from saturated or unsaturated C6-C30 linear, branched, or alicyclic moieties. In any one or more embodiments of formula (2), one or more of R⁷, R⁸, and R⁹ are C16-C20 linear moieties. In any one or more embodiments of formula (2), one or more of R⁷, R⁸, and R⁹ are unsaturated.

In some first embodiments, at least one of the one or more fatty acid triglycerides is derived from a plant source. Suitable plant sources include whole plants, seeds, stems, flowers, roots, or two or more thereof from cotton, flax, grape, hemp, safflower, olive, palm, peanut, rice, avocado, canola, coconut, corn, sesame, soybean, sunflower, walnut, or any combination thereof. Accordingly, in any one or more first embodiments, the one or more triglycerides are present in a plant oil, are a plant oil, or are part of a plant oil, that is, safflower oil, corn oil, and the like, and is extracted from a plant source. Each type of plant oil includes a characteristic blend of triglycerides, as well as one or more free fatty acids (that is, saturated or unsaturated C6-C30 linear, branched, or alicyclic carboxylic acids or a salt thereof) and in some cases diglycerides and monoglycerides of one or more fatty acids, either as part of the characteristic plant mixture, or as impurities including e.g. impurities arising from refining and/or processing thereof.

For example, as reported in “Corn oil, industrial and retail, all purpose salad or cooking, fat composition, 100 g”, (US National Nutrient Database, Release 28, United States Department of Agriculture; SR Legacy released April 2018) 100 g of corn oil includes a characteristic mixture of triglycerides, wherein the fatty acid moieties represented by R⁷, R⁸, and R⁹ of formula (2) correspond to about 12.9 g saturated fatty acid moieties, about 27.6 g monounsaturated fatty acid moieties, and about 54.7 g polyunsaturated fatty acid moieties. Additionally, about 99% of the unsaturated fatty acid moieties of corn oil are oleic acid moieties.

In some first embodiments, the modifier composition further includes one or more additional fatty acids or a conjugate base thereof, that is, one or more saturated or unsaturated C6-C30 linear, branched, or alicyclic carboxylic acids or a salt thereof, added to the mixture of fatty acid triglyceride and alkoxylated fatty alcohol. In such embodiments, the fatty acid is added in an amount of 0.1 wt % to 50 wt % of a modifier composition, such that the fatty acid is no more than 50 wt % of the modifier composition, with the mixture of fatty acid triglyceride and alkoxylated fatty alcohol being the remainder of the modifier composition. In some such embodiments, the additional fatty acid or salt thereof is selected from oleic acid, linoleic acid, linolenic acid, tall oil fatty acid, ricinoleic acid, or a combination of two or more thereof.

In some first embodiments, the modifier composition is provided neat, or added to a composition neat, that is, in the absence of a solvent (also referred to as “100% actives”). In other first embodiments, the modifier composition further includes a solvent. In embodiments, the solvent comprises, consists essentially of, or consists of one or more C5-C30 hydrocarbons, one or more C2-C12 alcohols, a petroleum distillate such as CAS No. 64741-44-2, a heavy aromatic solvent such as heavy aromatic naphtha, CAS No. 64742-94-5, toluene, a xylene, a cumene, or any combination thereof. In embodiments, the solvent is water. In embodiments, the modifier composition is present at 0.1 wt % to 99.9 wt % in a solvent, for example 0.1 wt % to 0.5 wt %, or 0.5 wt % to 1 wt %, or 1 wt % to 1.5 wt %, or 1.5 wt % to 2.0 wt %, or 2.0 wt % to 2.5 wt %, or 2.5 wt % to 3.0 wt %, or 3.0 wt % to 5.0 wt %, or 5.0 wt % to 10.0 wt %, or 10 wt % to 15 wt %, or 15 wt % to 20 wt %, or 20 wt % to 25 wt %, or 25 wt % to 30 wt %, or 30 wt % to 35 wt %, or 35 wt % to 40 wt %, or 40 wt % to 45 wt %, or 45 wt % to 50 wt %, or 50 wt % to 60 wt %, or 60 wt % to 70 wt %, or 70 wt % to 80 wt %, or 80 wt % to 90 wt %, or 90 wt % to 99 wt %, or 99 wt % to 99.9 wt %, or 90 wt % to 99.9 wt %, or 95 wt % to 99 wt %, or 95 wt % to 99.9 wt % in a solvent. In embodiments, the solvent consists essentially of or consists of water, and the modifier composition or a component thereof is present at 90 wt % to 99.9 wt % in the solvent. In other embodiments, the solvent comprises, consists essentially of, or consists of a petroleum distillate, wherein the modifier composition or a component thereof is present at 50 wt % to 90 wt % in the solvent.

### Second Embodiments

Disclosed in second embodiments herein are sparge compositions comprising, consisting essentially of, or consisting of a medium comprising water; a mineral ore comprising a beneficiary and a gangue; a collector; and a modifier composition of any of first embodiments above.

In any one or more sparge compositions of second embodiments, the medium comprising water is a liquid medium comprising, consisting essentially of, or consisting of fresh water, sea water, brackish water, tap water, water obtained from a creek, river, or pond, including sedimentation pond; runoff water, industrial waste water, water diverted from or obtained from a water treatment facility, or any combination thereof. The medium comprising water is present in a sparge composition of any one or more second embodiments in an amount of 30% to 80% by volume based on the weight of the ore, for example about 30% to 50%, or even about 60% to 80% by volume based on the weight of the ore.

In any one or more sparge compositions of second embodiments, the mineral ore is a solid material mined from one or more subterranean excavations and comprising, consisting essentially of, or consisting of a beneficiary and a gangue. In any one or more sparge compositions of second embodiments, the mineral ore comprises, consists essentially of, or consists of a phosphate ore, a lithium ore, or an iron ore. In any one or more sparge compositions of second embodiments herein, the amount of a mineral ore in a sparge composition is about 1% to 80%, in embodiments about 10% to 40%, or even about 20% to 30% by weight of the sparge composition.

As used herein, “phosphate ore” means a mineral ore that comprises a beneficiary comprising a phosphate group and/or phosphate moiety. As used herein, “phosphate” refers to a material comprising a phosphoric acid moiety or a salt thereof comprising PO₄³⁻, HPO₄²⁻, H₂PO₄, or any combination thereof as specified or determined by context herein. Accordingly, a phosphate beneficiary is a beneficiary comprising a phosphate group and/or phosphate moiety. In embodiments, a phosphate ore comprises or consists essentially a combination of one or more of Ca²⁺, PO₄³⁻, F⁻, OH⁻, CO₃²⁻, silica and/or silicate. In embodiments, a phosphate ore comprises a gangue comprising one or more carbonate anions, one or more silicate anions, more or more silicas, or any combination thereof. In embodiments, a phosphate ore comprises a gangue comprising calcite, dolomite, a silicate, silica, or any combination thereof. In embodiments, a phosphate beneficiary comprises, consists of, or consists essentially of Ca²⁺ and PO₄³⁻. In embodiments, a phosphate ore comprises an apatite, such as fluorapatite, hydroxyapatite, chlorapatite, or any combination thereof. In embodiments, the phosphate ore gangue comprises calcite, dolomite, a silicate, silica, a seashell or seashell portion, or any combination thereof.

As used herein, “lithium ore” means a mineral ore comprising, consisting essentially of, or consisting of a pegmatite, a Zinnwaldite, a Jadarite, or a lithium mica. A lithium ore is a solid material mined from one or more subterranean excavations and containing at least 0.1% by weight of a lithium-bearing compound or mineral, such as spodumene, calculated as wt % Li₂O:stated differently, a suitable lithium ore source has a “lithium potential” of at least 0.1% lithium as Li₂O. In embodiments, the lithium ore source has a lithium potential between 0.1% and 10% lithium as Li₂O, for example 0.5% to 8%, or 1% to 8%, or 1% to 6%, often between 1% and 4% lithium as Li₂O. In embodiments the lithium ore source further includes one or more of quartz, clay, feldspar, or another mineral having silicon, aluminum, iron, and/or magnesium content.

As used herein, “iron ore” refers to an ore including at least 20% by weight of one or more iron compounds, often between 30% and 55% by weight of one or more iron compounds. Typically the iron compounds are in the form of iron oxides such as hematite, magnetite and goethite. In embodiments, an iron ore contains one or more silica, alumina, phosphorous or sulfur compounds. Often, an iron ore includes between 10% and 45% SiO₂ by weight.

In any one or more sparge compositions of second embodiments, the mineral ore is a comminuted ore, that is, the mineral ore is comminuted after mining, and before addition of the remaining components of the sparge composition. In some such embodiments, a comminuted ore, such as a comminuted phosphate ore, a comminuted lithium ore, or a comminuted iron ore has a particle size as measured by ASTM C136 of 90% less than 4000 microns (#4 US standard mesh), in embodiments about 90% less than 1500 microns, in embodiments 90% less than 1000 microns, in embodiments 90% less than 500 microns, or in embodiments 90% less than 250 microns as measured by ASTM C136.

In any one or more sparge compositions of second embodiments, 1% to 99% by weight of a comminuted ore has a particle size as measured by ASTM C136 from about 38 microns to about 250 microns, in embodiments 50% to 80% by weight of the comminuted ore has a particle size from about 38 microns to about 250 microns, in embodiments 60% to about 70% has a particle size from about 38 microns to about 250 microns, in embodiments 65% to 70% has a particle size from about 38 microns to about 250 microns, or in embodiments about 68% has a particle size from about 38 microns to about 250 microns as measured by ASTM C136.

In any one or more sparge compositions of second embodiments, the weight proportion of the mineral ore to the modifier composition of any one of first embodiments in the sparge composition is about 1000:1 to 2:1, for example 1000:1 to 500:1, or 500:1 to 400:1, or 400:1 to 300:1, or 300:1 to 200:1, or 200:1 to 100:1, or 100:1 to 90:1, or 90:1 to 80:1, or 80:1 to 70:1, or 70:1 to 60:1, or 60:1 to 50:1, or 50:1 to 40:1, or 40:1 to 30:1, or 30:1 to 20:1, or 20:1 to 10:1, or 10:1 to 5:1, or 5:1 to 2:1, or 3:1 to 2:1, or 500:1 to 100:1, or 100:1 to 2:1, or 100:1 to 10:1, or 10:1 to 2:1 by weight of the mineral ore to the modifier composition in the sparge composition.

In any one or more sparge compositions of second embodiments, the collector comprises, consists essentially of, or consists of one or more C12-C30 fatty acids, one or more C12-C30 fatty acid salts, one or more C12-C30 sulfonated fatty acids, one or more C12-C30 sulfonated fatty acid salts, or any combination of these. In some such embodiments, the collector comprises, consists essentially of, or consists of oleic acid, an oleic acid salt, a sulfonated oleic acid, a sulfonated oleic acid salt, linoleic acid, a linoleic acid salt, a sulfonated linoleic acid, a sulfonated linoleic acid salt, linolenic acid, a linolenic acid salt, a sulfonated linolenic acid, a sulfonated linolenic acid salt, ricinoleic acid, a ricinoleic acid salt, a sulfonated ricinoleic acid, a sulfonated ricinoleic acid salt, palmitoleic acid, a palmitoleic acid salt, a sulfonated palmitoleic acid, a sulfonated palmitoleic acid salt, 11-eicosenoic acid, an 11-eicosenoic acid salt, a sulfonated 11-eicosenoic acid, a sulfonated 11-eicosenoic acid salt, erucic acid, an erucic acid salt, a sulfonated erucic acid, a sulfonated erucic acid salt, nervonic acid, a nervonic acid salt, a sulfonated nervonic acid, a sulfonated nervonic acid salt, or any combination thereof.

In any one or more sparge compositions of second embodiments, the collector is present in an amount of about 0.001% to 3% by weight or by weight/volume in a sparge composition, in embodiments about 0.01% to 0.5%, about 0.01% to 0.2%, or about 0.01% to 0.1% by weight or by weight/volume in a sparge composition.

In any one or more sparge compositions of second embodiments, the collector comprises, consists of, or consists essentially of a sulfonated fatty acid composition. In embodiments, the sulfonated fatty acid composition comprises, consists of, or consists essentially of one or more sulfonated fatty acids, one or more sulfonated fatty acid salts, or any combination thereof. In some embodiments, the one or more sulfonated fatty acids, one or more sulfonated fatty acid salts, or the combination thereof comprises, consists of, or consists essentially of a sulfonated fatty acid, a sulfonated fatty acid salt, or a combination thereof.

In any one or more sparge compositions of second embodiments, a sulfonated fatty acid composition comprises, consists of, or consists essentially of a compound or mixture of compounds that is a product of a sulfonation of one or more fatty acids and/or salts thereof, or is the product of neutralizing or partially neutralizing with a base the compound or mixture of compounds that is a product of a sulfonation of the one or more fatty acids; further wherein each compound present in the sulfonated fatty acid composition comprises at least one —COOH group or salt thereof, and at least one —SO₃H group or salt thereof. The compound or each compound in the mixture of compounds has a —COOH group or a —CO₂ group, and at least one —SO₃H group or SO₃⁻ group. Therefore, the sulfonated fatty acid composition comprises one or more fatty acids having sulfonic acid groups and/or salts thereof.

In any one or more sparge compositions of second embodiments, a sulfonated fatty acid composition comprises, consists of, or consists essentially of sulfonated oleic acid, a sulfonated oleic acid salt, sulfonated linoleic acid, a sulfonated linoleic acid salt, sulfonated linolenic acid, a sulfonated linolenic acid salt, sulfonated ricinoleic acid, a sulfonated ricinoleic acid salt, sulfonated palmitoleic acid, a sulfonated palmitic acid salt, sulfonated 11-eicosenoic acid, a sulfonated 11-eicosenoic acid salt, sulfonated erucic acid, a sulfonated erucic acid salt, sulfonated nervonic acid, a sulfonated nervonic acid salt, sulfonated abietic acid, a sulfonated abietic acid salt, or any combination thereof.

In any one or more sparge compositions of second embodiments, a sulfonated fatty acid composition comprises one or more sulfonated fatty acid sodium salts, one or more sulfonated fatty acid potassium salts, one or more sulfonated fatty acid ammonium salts, or any combination thereof. In embodiments, the ammonium is selected from inorganic ammonium (NH₄⁺), primary organic ammonium, secondary organic ammonium, tertiary organic ammonium, quaternary organic ammonium, or any combination thereof. In embodiments, a sulfonated fatty acid composition is a neutralized or partly neutralized product of a sulfonation of a saturated fatty acid with a sulfonating agent. In this context, neutralized or partially neutralized means reacted with a base. In embodiments, the sulfonating agent is selected from sulfur trioxide, oleum, chlorosulfonic acid, and sulfuric acid.

In any one or more sparge compositions of second embodiments, a sulfonated fatty acid composition comprises, consists of, or consists essentially of a sulfonated oleic acid potassium salt. In any one or more sparge compositions of second embodiments, a sulfonated fatty acid composition comprises, consists of, or consists essentially of a fatty acid monosulfonate, a fatty acid disulfonate, one or more fatty acid sulfonate dimers, one or more fatty acid sulfonate trimers, or any combination thereof. In some such embodiments, the sulfonated fatty acid composition comprises a salt of the fatty acid monosulfonate, a salt of the fatty acid disulfonate, one or more salts of the one or more fatty acid sulfonate dimers, one or more salts of the fatty acid sulfonate trimers, or any combination thereof.

A fatty acid monosulfonate is a monosulfonated compound that is a product of a sulfonation of a fatty acid, the monosulfonated compound comprising one —SO₃H or one —SO₃⁻ group per molecule of the monosulfonated compound. A fatty acid disulfonate is a disulfonated compound that is a product of a sulfonation of a fatty acid, the disulfonated compound comprising two —SO₃H groups, two —SO₃⁻ groups, or one —SO₃H and one —SO₃⁻ group per molecule of the disulfonated compound. A fatty acid sulfonate dimer is a compound resulting from a chemical combination of a fatty acid sulfonate or its salt with a fatty acid, a fatty acid salt, a fatty acid sulfonate, or a salt of a fatty acid sulfonate.

A fatty acid sulfonate trimer is a compound resulting from a combination of two molecules of a fatty acid and/or its salt with one molecule of a fatty acid sulfonate or its salt; one molecule of a fatty acid or its salt and two molecules of a fatty acid and/or its salt; and/or three molecules of a fatty acid sulfonate and/or its salt.

In the way of illustration only, in one non-limiting example, a sulfonated fatty acid employed in any of second embodiments herein is derived from a sulfonation of oleic acid and comprises unsaturated oleic acid monosulfonate (I), a salt of unsaturated oleic acid monosulfonate (I), saturated hydroxy oleic acid monosulfonate (II), a salt of saturated hydroxy oleic acid monosulfonate (II), oleic acid 8,10-disulfonate (III), a salt of oleic acid 8,10-disulfonate (III), oleic acid 9,10-disulfonate (IV), a salt of oleic acid 9,10-disulfonate (IV), dimer (V), a salt of dimer (V), hydroxy sulfonated dimer (VI), a salt of hydroxy sulfonated dimer (VI), sulfonated dimer (VII), a salt of sulfonated dimer (VII), saturated dimer (VIII), a salt of saturated dimer (VIII), trimer (IX), a salt of trimer (IX), saturated trimer (X), a salt of saturated trimer (X), doubly unsaturated dimer (XI), a salt of doubly unsaturated dimer (XI), C14-C18 dimer (XII), a salt of C14-C18 dimer (XII), monounsaturated dimer (XIII), a salt of monounsaturated dimer (XIII), C18-C14 dimer (XIV), a salt of C18-C14 dimer (XIV), or any combination thereof. In such embodiments, the fatty acid salt composition comprises, consists of, or consists essentially of a salt or salts of any one or more of (I), (II), (III), (IV), (V), (VI), (VII), (VIII), (IX), (X), (XI), (XII), (XIII), and (XIV).

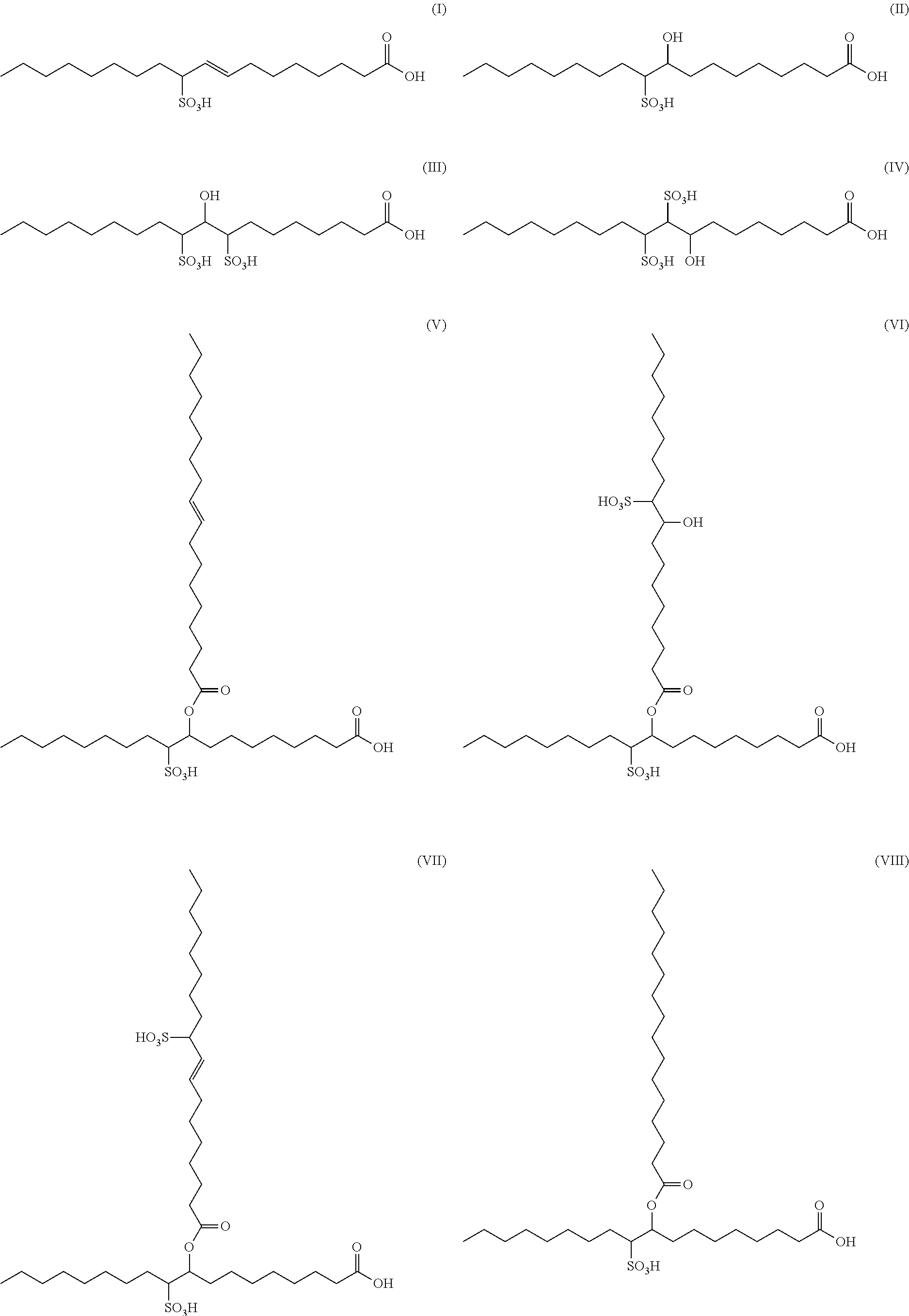

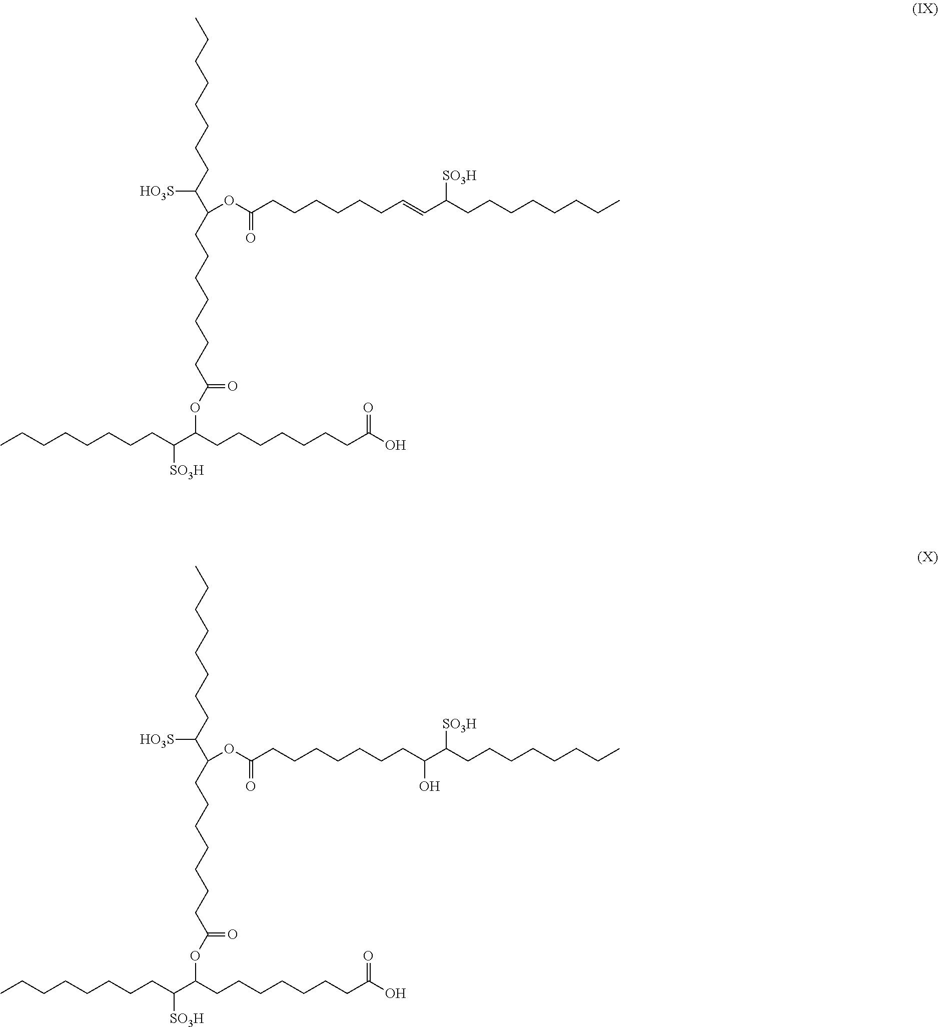

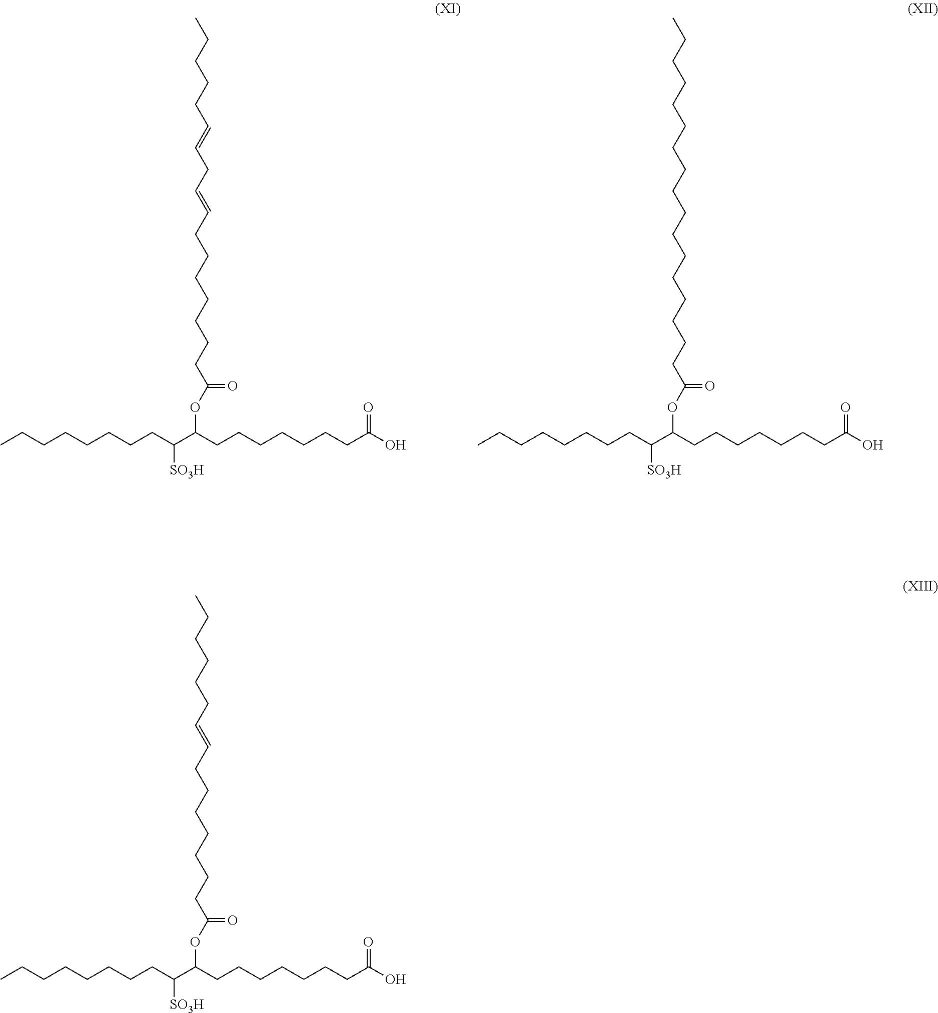 [SMILES: CCCCC/C=C/C/C=C/CCCCCCCC(=O)OC(CCCCCCCC(=O)O)C(CCCCCCCC)S(=O)(=O)O ; CCCCCCCCCCCCCCCCCC(=O)OC(CCCCCCCC(=O)O)C(CCCCCCCC)S(=O)(=O)O ; CCCCCC/C=C/CCCCCCCC(=O)OC(CCCCCCCC(=O)O)C(CCCCCCCC)S(=O)(=O)O]

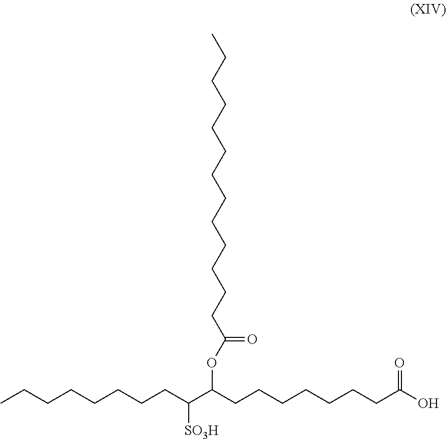 [SMILES: CCCCCCCCCCCCCC(=O)OC(CCCCCCCC(=O)O)C(CCCCCCCC)S(=O)(=O)O]

Sulfonation of other fatty acids other than oleic acid as exemplified above can also produce a mixture of compounds. The mixture of compounds in such embodiments depends on the fatty acid or mixture thereof that is sulfonated.

Saturated and unsaturated fatty acids can be sulfonated by means known in the art to produce sulfonated fatty acids and their salts useful as collectors in any one or more sparge compositions of second embodiments. The sulfonation of both saturated and unsaturated fatty acids is described for example, in U.S. Pat. No. 1,926,442. In any one or more sparge compositions of second embodiments, a sulfonated fatty acid salt composition comprises, consists of, or consists essentially of one or more salts of a sulfonated saturated fatty acid, one or more salts of a sulfonated unsaturated fatty acid, salts of more than one sulfonated saturated fatty acid, salts of more than one unsaturated fatty acid, or any combination thereof.

In any one or more sparge compositions of second embodiments, the sparge composition further includes a pH adjustment agent, such as an acid selected from phosphoric acid, sulfuric acid, hydrochloric acid, acetic acid, citric acid, a polymeric acid, or any combination thereof; or a base selected from sodium carbonate, potassium carbonate, sodium bicarbonate, potassium bicarbonate, sodium hydroxide, potassium hydroxide, or any combination thereof. The pH adjustment agent is added to any one or more of the sparge compositions of second embodiments in order to adjust a pH of the sparge composition to a targeted value. Accordingly, in some second embodiments, a sparge composition includes, is present at, or is adjusted to have a pH between 2.5 and 7, for example between 3 and 7, between 3.5 and 7, between 4 and 7, between 4.5 and 7, or between 5 and 7. In some sparge compositions of second embodiments, a sparge composition has a targeted pH value between 2.5 and 7, which is beneficial for froth flotation of phosphate ore and iron ore, as disclosed in methods of third embodiments below. In some other sparge compositions of second embodiments, a sparge composition has a targeted pH value between 7 and 12, which is beneficial for froth flotation of phosphate ore and lithium ore, as disclosed in methods of third embodiments below.

In any one or more sparge compositions of second embodiments, the sparge composition further includes a beneficiating agent. As used herein, “beneficiating agent” means a material or mixture of materials that increases the partitioning of a beneficiary in a froth flotation, or increases the yield of a beneficiary collected from a froth flotation, and optionally further improves froth characteristics when compared with an otherwise identical sparge composition absent the beneficiating agent.

In any one or more sparge compositions of second embodiments, the beneficiating agent comprises, consists essentially of, or consists of one or more hydroxy fatty acids, one or more hydroxy fatty acid salts, or any combination thereof. As used herein, a “hydroxy fatty acid” is any fatty acid having at least one hydroxyl group. Accordingly, a hydroxy fatty acid comprises a hydrocarbon chain with at least one hydroxyl group and at least one carboxyl group attached thereto. In embodiments, the hydrocarbon chain has one, two, or three hydroxyl groups attached thereto. In embodiments, the hydrocarbon chain is aliphatic. In embodiments the hydrocarbon chain is branched or straight-chain. In some embodiments the hydrocarbon chain includes at least one —C═C— double bond, in other embodiments the hydrocarbon chain is saturated. In embodiments, the hydrocarbon chain includes one —C═C— double bond or two —C═C— double bonds. In embodiments, the hydrocarbon chain comprises 5 to 50 carbon atoms, in embodiments 10 to 30 carbon atoms, in embodiments 15 to 25 carbon atoms, in embodiments 15 to 21 carbon atoms, or in embodiments 16 to 20 carbon atoms. In embodiments, the hydroxy fatty acid composition comprises two or more hydroxy fatty acids differing from each other with respect to number of carbon atoms in the hydrocarbon chain.

In any one or more sparge compositions of second embodiments, the hydroxy fatty acid comprises, consists of, or consists essentially of a compound having formula (3)

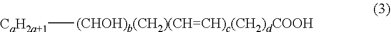

and/or a salt thereof, wherein a is an integer from 1 to 10; b is an integer from 1 to 5; c is 0 or 1; and d is an integer from 5 to 10. In some embodiments where c=1, the CH═CH is cis, in other such embodiments the CH═CH is trans. In some embodiments, the CₐH₂ₐ₊₁ group is a linear n-alkyl group. In other embodiments, the CₐH₂ₐ₊₁ group is a branched alkyl group.

In any one or more sparge compositions of second embodiments, the hydroxy fatty acid composition comprises, consists of, or consists essentially of a fatty acid having formula (4),

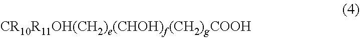

and/or a salt thereof, wherein R₁₀ and R₁₁ are independently selected from C1-C5 alkyl and hydrogen; e is an integer from 1 to 10; f is 0 or an integer from 1 to 5; and g is an integer from 1 to 20. In some such embodiments, R₁₀ and R₁₁ are both hydrogen.

In any one or more sparge compositions of second embodiments, the hydroxy fatty acid composition comprises, consists of, or consists essentially of a hydroxy fatty acid having formula (5),

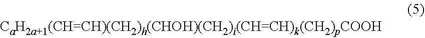

and/or a salt thereof, wherein a is an integer from 1 to 10; h is an integer from 1 to 10; i is 0 or an integer from 1 to 10; k is 0 or 1, with the proviso that if i=0 then k=0; and p is 0 or an integer from 1 to 10. In some such embodiments, every CH═CH is cis, in some other such embodiments every CH═CH is trans, in still other such embodiments, the hydroxy fatty acid has one cis CH═CH and one trans (CH═CH). In some embodiments, CₐH₂ₐ₊₁ is a linear n-alkyl group.

In any one or more sparge compositions of second embodiments, the hydroxy fatty acid composition comprises a fatty acid having formula (6),

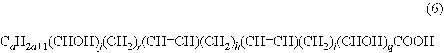

and/or a salt thereof, wherein a is an integer from 1 to 10; j is 0 or an integer from 1 to 5; r is 0 or an integer from 1 to 10, with the proviso that if j>0 then r is at least 1; h is an integer from 1 to 10; q is 0 or 1, with the proviso that j+q>0; and i is 0 or an integer from 1 to 7, with the proviso that if i is 0 then q is also 0. In some such embodiments, both CH═CH moieties are cis, in other such embodiments both CH═CH are trans, in still other such embodiments, one CH═CH group is cis and the other CH═CH group is trans.

In any one or more sparge compositions of second embodiments, the hydroxy fatty acid composition comprises, consists of, or consists essentially of a hydroxy fatty acid having formula (7),

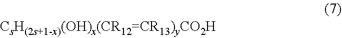

and/or a salt thereof, wherein s is an integer from 5 to 25, x is an integer from 1 to 5, y is 0 or an integer from 1 to 3, and R₁₂ and R₁₃ are independently selected from alkyl or hydrogen. In this context, the empirical formula CₛH₍₂ₛ₊₁₋ₓ₎(OH)ₓ (CH═CH)_{y}CO₂H means that a molecule of the hydroxy fatty acid comprises one —COOH group, from 1 to 5 —OH groups, and at least one alkyl and/or alkylene group; but the empirical formula does not indicate the arrangement of these groups in the molecule. For example, CₛH₍₂ₛ₊₁₋ₓ₎(OH)ₓ can be split up by one or more intervening CH═CH double bonds into two or more alkylene groups or two or more alkylene groups and an alkyl group. Furthermore, CₛH₍₂ₛ₊₁₋ₓ₎(OH)ₓ can have any arrangement with respect to (OH) groups. In embodiments, CR₁₂=CR₁₄ is cis; in other embodiments, CR₁₂=CR₁₄ is trans.

In any one or more sparge compositions of second embodiments, the hydroxy fatty acid composition comprises, consists of, or consists essentially of ricinoleic acid, a salt of ricinoleic acid, 12-hydroxystearic acid, a salt of 12-hydroxystearic acid, 9,10-dihydroxyoctadecanoic acid, a salt of 9,10-dihydroxyoctadecanoic acid, 9,10,18-trihydroxyoctadecanoic acid (phloionolic acid), a salt of phloionolic acid, lesquerolic acid (n-C₆H₁₃(CHOH)CH₂(CH═CH)(CH₂)₉COOH), a salt of lesquerolic acid, 15-hydroxyhexadecanoic acid, a salt of 15-hydroxyhexadecanoic acid, isoricinoleic acid (cis n-C₅H₁₁(CH═CH)(CH₂)₂(CHOH)(CH₂)₇COOH), a salt of isoricinoleic acid, densipolic acid (cis, cis n-C₂H₅(CH═CH)(CH₂)₂(CHOH)CH₂(CH═CH)(CH₂)₇COOH), a salt of densipolic acid, 14-hydroxy-eicosa-cis-11-cis-17-dienoic acid (auricolic acid, n-C₂H₅(CH═CH)(CH₂)₂(CHOH)CH₂(CH═CH)(CH₂)₉COOH)), a salt of auricolic acid, 2-hydroxyoleic acid, a salt of 2-hydroxyoleic acid, 2-hydroxylinoleic acid, a salt of 2-hydroxylinoleic acid, 18-hydroxystearic acid, a salt of 18-hydroxystearic acid, 15-hydroxylinoleic acid, a salt of 15-hydroxylinoleic acid, or any combination thereof.

In any one or more sparge compositions of second embodiments, the hydroxy fatty acid composition comprises, consists of, or consists essentially of sodium ricinoleate, potassium ricinoleate, sodium 12-hydroxystearate, potassium 12-hydroxystearate, sodium 9,10-dihydroxyoctadecanoate, potassium 9,10-dihydroxyoctadecanoate, sodium phloionolate, potassium phloionolate acid, sodium lesquerolate, potassium lesquerolate, sodium 15-hydroxyhexadecanoate, potassium 15-hydroxyhexadecanoate, sodium isoricinoleate, potassium isoricinoleate, sodium densipolate, potassium densipolate, sodium auricolate, potassium auricolate, sodium 2-hydroxyoleate, potassium 2-hydroxyoleate, sodium 2-hydroxylinoleate, potassium 2-hydroxylinoleate, sodium 18-hydroxystearate, potassium 18-hydroxystearate, sodium 15-hydroxylinoleate, potassium 15-hydroxylinoleate, or any combination thereof.

In any one or more sparge compositions of second embodiments, the beneficiating agent comprises, consists of, or consists essentially of a salt of ricinoleic acid. In some such embodiments, the salt of the ricinoleic acid is the product of the hydrolysis of castor oil. In embodiments, the hydrolysis of the castor oil is a saponification of the castor oil with an alkali. In embodiments, the alkali is selected from aqueous sodium hydroxide, aqueous potassium hydroxide, or an aqueous ammonium hydroxide. In embodiments, the ammonium of the aqueous ammonium hydroxide is selected from inorganic ammonium, primary organic ammonium, secondary organic ammonium, tertiary organic ammonium, quaternary organic ammonium, or any combination thereof. In embodiments, the salt of the ricinoleic acid comprises, consists of, or consists essentially of sodium ricinoleate or potassium ricinoleate. In some such embodiments, the sodium ricinoleate or potassium ricinoleate is the product of the saponification of castor oil with aqueous sodium hydroxide or aqueous potassium hydroxide respectively.

In any one or more sparge compositions of second embodiments, the salt of the hydroxy fatty acid is selected from an ammonium salt, a sodium salt, or a potassium salt of the hydroxy fatty acid. In embodiments, the ammonium is inorganic ammonium (NH₄⁺), primary organic ammonium, secondary organic ammonium, tertiary organic ammonium, or quaternary organic ammonium.

In any one or more sparge compositions of second embodiments, a hydroxy fatty acid, a salt of the hydroxy fatty acid, or a combination thereof is a product of hydrolysis of a natural oil. In embodiments, the natural oil is castor oil. In embodiments, the hydrolysis is a saponification with an alkali. In embodiments, the alkali comprises, consists of, or consists essentially of aqueous sodium hydroxide, aqueous potassium hydroxide, an aqueous ammonium hydroxide, or any combination thereof. In any one or more sparge compositions of second embodiments, the hydroxy fatty acid, the salt of the hydroxy fatty acid, or the combination thereof is a product of hydrolysis of a triglyceride that is the ester of at least one hydroxy fatty acid. In embodiments, the hydrolysis is a saponification with an alkali. In embodiments, the alkali comprises, consists of, or consists essentially of aqueous sodium hydroxide, aqueous potassium hydroxide, an aqueous ammonium hydroxide, or any combination thereof.

In any one or more sparge compositions of second embodiments, the hydroxy fatty acid composition comprises two or more hydroxy fatty acids, two or more salts of a single species of hydroxy fatty acid, two or more salts of two or more hydroxy fatty acids, or any combination thereof.

In any one or more sparge compositions of second embodiments, a beneficiating agent is present in an amount of about 0.001% to 5% by weight or by weight/volume in a sparge composition, in embodiments about 0.01% to 0.5%, about 0.02% to 0.15%, or about 0.03% to 0.12% by weight or by weight/volume in a sparge composition.

In any one or more sparge compositions of second embodiments, the beneficiating agent comprises, consists of, or consists essentially of a hydroxy fatty acid or salt thereof and the collector comprises, consists of, or consists essentially of a sulfonated fatty acid or salt thereof, wherein the weight of the sulfonated fatty acid divided by the weight of the hydroxy fatty acid present in the sparge composition, or the weight of the sulfonated fatty acid salt divided by the weight of the hydroxy fatty acid salt present in the sparge composition is about 0.01 to about 99, for example about 0.05 to 1.2, or about 0.05 to 1.1, or about 0.1 to 1.1, or about 0.1 to 1, or its about 0.20 to 1.0, or about 0.30 to 1.0, or about 0.40 to 1.0, or in embodiments about 0.66. In any one or more sparge compositions of second embodiments, the sum of the weight of the sulfonated fatty acid plus the weight of the hydroxy fatty acid is about 0.001% to about 5% of the weight of the mineral ore present in the sparge composition, for example about 0.001% to 1%, or about 0.01% to about 1%, or about 0.05% to about 0.7%, or about 0.1% to about 0.3% of the weight of the mineral ore. In any one or more sparge compositions of second embodiments, the sum of the weight of the sulfonated fatty acid salt plus the weight of the hydroxy fatty acid salt is about 0.001% to about 7% of the weight of the mineral ore present in the sparge composition, for example about 0.001% to 5%, or about 0.01% to about 4%, or about 0.05% to about 1.0%, or about 0.1% to about 0.7% of the weight of the mineral ore.

In any one or more sparge compositions of second embodiments, a sparge composition further includes one or more additional components selected from one or more emulsifying surfactants, one or more additional collectors, one or more depressants, one or more activators, one or more frothing agents, or any combination thereof, wherein the amount of any one or more additional component present in the sparge composition is about 0.001% to about 5% of the weight of the mineral ore present in the sparge composition

For example, in any one or more sparge compositions of second embodiments, a sparge composition further includes one or more additional fatty acids or conjugate bases thereof, that is, one or more saturated or unsaturated C6-C30 linear, branched, or alicyclic carboxylic acids, or a salt thereof. In any one or more such embodiments, the fatty acid is added in an amount of 0.001% to about 5% of the weight of the mineral ore present in the sparge composition, for example about 0.001% to 4%, or about 0.01% to 3%, or about 0.05% to 2%, or about 0.01% to 1%, or about 0.001% to 0.01%, or about 0.01% to 0.1%, or about 0.1% to 1% or about 1% to 2%, or about 2% to 3%, or about 3% to 4%, or about 4% to 5% of the weight of the mineral ore.

Any one or more sparge compositions of second embodiments herein are used for froth flotation employing methods described in third embodiments herein. Any one or more sparge compositions of second embodiments herein are used for reverse froth flotation employing the methods described in third embodiments herein.

### Third Embodiments

Disclosed in third embodiments herein are methods of froth flotation comprising, consisting essentially of, or consisting of forming a sparge composition of any of second embodiments above; and sparging the sparge composition to form a sparged slurry, the sparged slurry having an overflow and an underflow. Accordingly, in any one or more methods of third embodiments herein, a method of froth flotation comprises, consists essentially of, or consists of combining a mineral ore comprising a beneficiary and a gangue, a medium comprising water, a collector, and a modifier composition of any of first embodiments to form a sparge composition in accordance with second embodiments herein; and sparging the sparge composition to yield a sparged slurry comprising an overflow and an underflow. During and after sparging, bubbles of gas migrate through the sparged composition to form layer of bubbles, or froth, at the liquid-air interface. The layer of bubbles is referred to herein as the overflow.

In any one or more methods of third embodiments herein, a method of froth flotation comprises, consists essentially of, or consists of combining the following components a, b, c, d, e to form a sparge composition in accordance with any one or more second embodiments:
a. a mineral ore comprising a beneficiary and a gangue,
b. a medium comprising water,
c. a collector,
d. a fatty acid triglyceride, and
e. an alkoxylated fatty alcohol;
   and sparging the sparge composition to yield a sparged slurry comprising an overflow and an underflow.

In any one or more methods of third embodiments herein, components a, b, c, d, and e are defined and described in first and second embodiments herein. Accordingly, in any one or more methods of third embodiments, component a is a mineral ore in accordance with any one or more second embodiments herein; component b is a medium in accordance with any one or more second embodiments herein; component c is a collector in accordance with any one or more second embodiments herein; component d is a fatty acid triglyceride in accordance with any one or more first or second embodiments herein; and component e is an alkoxylated alcohol in accordance with any one or more first or second embodiments herein.

In any one or more methods of third embodiments herein, components a, b, c, d, and e are combined in any order to form a sparge composition. In any one or more methods of third embodiments herein, components c and e are combined, then the c+e combination is further combined with components a, b, and d in any order. In any one or more methods of third embodiments herein, components d and e are combined, then the d+e combination is further combined with components a, b, and c in any order. In any one or more methods of third embodiments herein, components a and b are combined, then the a+b combination is further combined with components c, d, and e in any order. In any one or more methods of third embodiments herein, components a and b are combined, then the a+b combination is further combined with components c, d, e, in order; or components c, e, d in order. In any one or more methods of third embodiments herein, components d and e are combined to form a d+e combination, components a, b, and c are separately combined in any order to form an a+b+c combination; and then the d+e combination is combined with the a+b+c combination.

In any one or more methods of third embodiments herein, a method further comprises combining component f,
f. a pH adjustment agent
   with a sparge composition or with one or more components a, b, c, d, or e listed above. The pH adjustment agents of third embodiments are the same as the pH adjustment agents of second embodiments herein. Accordingly, in any one or more methods of third embodiments herein, components a, b, c, d, e, and f are combined in any order to form a sparge composition. In any one or more methods of third embodiments herein, the combining comprises combining components a, b, c, d, e to form a sparge composition using any one of the orders of component combination listed above; then measuring a pH of the sparge composition, then adjusting pH to a target pH value that is different from the measured pH value by adding component f to the sparge composition. In accordance with the sparge composition targeted pH ranges of second embodiments herein, the targeted pH is 2.5 to 7 where component a (mineral ore) is a phosphate ore or a lithium ore; and the targeted pH is 7 to 12 where component a is a lithium ore or an iron ore.

In any one or more methods of third embodiments herein, a method further comprises combining component g,
g. a beneficiating agent
   with the sparge composition or with one or more components a, b, c, d, e, or f listed above, wherein the beneficiation agent is selected from any one or more of the beneficiation agents of second embodiments above.

In any one or more methods of third embodiments herein, components a, b, c, d, e, and g are combined in any order to form a sparge composition in accordance with one or more sparge compositions of second embodiments herein. Accordingly, in any one or more methods of third embodiments herein, components a, b, c, d, e, f, and g are combined in any order to form a sparge composition in accordance with one or more second embodiments herein. In any one or more methods of third embodiments herein, components c, and g are combined, then the c+g combination is further combined with components a, b, d, and e in any order to form a sparge composition in accordance with any one or more second embodiments herein. In any one or more methods of third embodiments herein, components c, e, and g are combined, then the c+e+g combination is further combined with components a, b, and d in any order to form a sparge composition in accordance with any one or more second embodiments herein. In any one or more methods of third embodiments herein, components d and e are combined, then the d+e combination is further combined with components a, b, c, and g in any order in accordance with any one or more second embodiments herein. In any one or more methods of third embodiments herein, components a and b are combined, then the a+b combination is further combined with components c, d, e, and g in any order in accordance with any one or more second embodiments herein. In any one or more methods of third embodiments herein, components a and b are combined, components c and g are combined, then the a+b combination is further combined with the c+g combination, and then the a+b+c+g combination is further combined with component d, then component e, in order; or the a+b+c+g combination is further combined with component e, then component d, in order, to form a sparge composition in accordance with any one or more second embodiments herein. In any one or more methods of third embodiments herein, components d and e are combined to form a d+e combination, components a, b, c, and g are separately combined in any order to form an a+b+c+g combination; and then the d+e combination is combined with the a+b+c+g combination to form a sparge composition in accordance with any one or more second embodiments herein. In any one or more such methods of third embodiments herein, the method further comprises combining component f with any one or more components a, b, c, d, e, g, or with the sparge composition, as described above in order to provide a targeted pH.

In any one or more methods of third embodiments herein, the method further includes adjusting the pH of a sparge composition by combining the mineral ore, medium, collector, modifier composition, and optionally beneficiating agent with a pH adjustment agent. In any one or more methods of third embodiments herein, the pH adjustment agent is selected from any one or more of the pH adjustment agents of second embodiments. Accordingly, in some third embodiments, the method further includes combining a pH adjustment agent with the sparge composition prior to the sparging, in an amount sufficient to obtain a pH of about 2.5 to about 7, in accordance with some second embodiments herein; while in other third embodiments, the method further includes combining a pH adjustment agent with the ore slurry, or with the sparge composition prior to the sparging, in an amount sufficient to obtain a pH of about 7 to about 12, in accordance with other second embodiments herein.

In any one or more methods of third embodiments herein, the method further includes adding one or more emulsifying surfactants, one or more additional collectors, one or more depressants, one or more activators, one or more frothing agents, or any combination thereof to one or more of components a, b, c, d, e, f, or g; or to the sparge composition.

In any one or more methods of third embodiments herein, there is provided a method of sparging comprising: sparging any of the sparge compositions disclosed in second embodiments herein, to yield a sparged slurry. The sparged slurry comprises an overflow and an underflow.

In any one or more methods of third embodiments herein, the sparging is carried out in a lab scale flotation cell. In any one or more methods of third embodiments herein, the method further includes collecting an overflow, collecting an underflow, or collecting both an overflow and an underflow, wherein the collecting comprises, consists essentially of, or consists of separating at least a portion of an overflow from at least a portion of an underflow arising from sparging a sparge composition of any of second embodiments herein and formed using any of the methods of third embodiments herein. Separating at least a portion of an overflow, from at least a portion of an underflow is accomplished using conventional methods known to those of skill in the art of froth flotation. In any one or more methods of third embodiments herein, such separating comprises, consists of, or consists essentially of: tapping off at least a portion of the overflow, skimming off at least a portion of the overflow, depositing at least a portion of the overflow onto a launder, decanting at least a portion of the overflow, or any combination thereof.

In any one or more methods of third embodiments herein, the underflow comprises a concentrate and a first portion of the medium; and the overflow comprises tailings and a second portion of the medium. The concentrate comprises, consists of, or consists essentially of the beneficiary. The tailings comprise, consist of, or consist essentially of the gangue. In any one or more methods of third embodiments herein where the mineral ore is a phosphate ore, the underflow includes a phosphate beneficiary, and the overflow includes a gangue comprising a silica.

In any one or more methods of third embodiments herein, the method further comprises separating at least a portion of the concentrate from at least a portion of the tailings. In embodiments, the at least the portion of the concentrate is about 90% to 100% by weight of the concentrate in the underflow, in embodiments about 95% to 100%, in embodiments about 98% to 100%, in embodiments about 99% to 100%, or 100% by weight of the concentrate in the underflow. In embodiments the at least the portion of the tailings is about 90% to 100% by weight of the tailings in the froth, in embodiments about 95% to 100%, in embodiments about 98% to 100%, in embodiments about 99% to 100%, or 100% by weight of the tailings in the froth.

In any one or more methods of third embodiments herein, the separating the at least the portion of the concentrate from the at least the portion of the tailings comprises, consists of, or consists essentially of separating at least a portion of the overflow from at least a portion of the underflow, wherein the underflow comprises concentrate and the overflow comprises tailings. In some such embodiments, the method comprises separating at least a portion of a froth layer from at least a portion of the underflow.

### Fourth Embodiments

Disclosed in fourth embodiments herein is the use of any one or more of the sparge compositions of second embodiments, which include a modifier composition in accordance with any one or more first embodiments herein, to refine a mineral ore using reverse froth flotation and provide a refined mineral ore. In any one or more uses of fourth embodiments, the mineral ore is a phosphate ore; and the refined phosphate ore is used to produce phosphoric acid. In the phosphoric acid process, a phosphate ore and an acid such as sulfuric acid are combined and react together to produce phosphoric acid. The greater the proportion of gangue in the phosphate ore, the worse scaling problems and the like that can be encountered in the production of the phosphoric acid. Therefore, froth flotation can be used to produce a concentrate comprising a higher percentage of the phosphate than in the raw phosphate ore. In such a froth flotation, the higher the grade and the recovery of phosphate, the less problems that can be encountered in subsequent phosphoric acid manufacturing.

We previously determined that in reverse froth flotation of phosphate ores, increasing the dosage of collector tends to increase the % P₂O₅ in the concentrate (% grade) at the expense of % P₂O₅ recovery of concentrate: that is, improvements in mineral grade conventionally lead to reduced mineral recovery. Similarly, we have found that increasing the dosage of beneficiating agent increases the grade of P₂O₅ recovered at the expense of % recovery of P₂O₅.

However, in sharp contrast with observations and teachings of this conventional art, we have found that in the uses of fourth embodiments, reverse froth flotation of phosphate ores employing a modifier composition of any one of first embodiments in any one or more sparge compositions of second embodiments, and sparging in accordance with any one or more of the methods of third embodiments herein, obtains an increase of both % grade (wt % in a concentrate) and recovery (total wt % yield from the ore). For example, in any one or more fourth embodiments herein, the use of any one or more of the sparge compositions of second embodiments to refine a phosphate ore using reverse froth flotation in accordance with third embodiments herein obtains a refined phosphate ore having both improved yield and improved grade of phosphate recovered. This result is unexpected in view of conventional froth flotation art, which teaches that improvements in mineral grade conventionally lead to reduced mineral recovery.

Additionally, in any one or more fourth embodiments herein, the use of any one or more of the sparge compositions of second embodiments to refine a lithium ore using reverse froth flotation obtains a refined lithium ore having improved grade, improved recovery, or improved grade and recovery of the valuable lithium compound, compared to use of a conventional sparge composition for refining the lithium ore.

Additionally, in any one or more fourth embodiments herein, the use of any one or more of the sparge compositions of second embodiments to refine an iron ore using reverse froth flotation obtains a refined iron ore having improved grade, improved recovery, or improved grade and recovery of the valuable iron compound, compared to use of a conventional sparge composition for refining the iron ore.

### Fifth Embodiments

Disclosed in fifth embodiments herein are froth flotation processing kits comprising, consisting essentially of, or consisting of a first kit composition that is a modifier composition in accordance with first embodiments herein; and a second kit composition that is a collector composition comprising, consisting essentially of, or consisting of one or more sulfonated fatty acids, one or more sulfonated fatty acid salts, or any combination thereof in accordance with second, third, and fourth embodiments herein.

In any one or more kits of fifth embodiments herein, a first kit composition is a modifier composition of any one or more first embodiments, and accordingly comprises, consists essentially of, or consists of one or more alkoxylated fatty alcohols and one or more fatty acid triglycerides; and in some embodiments further includes a solvent, such as any one or more of the solvents disclosed in first embodiments above.

In any one or more kits of fifth embodiments, a second kit composition comprises, consists essentially of, or consists of a collector in accordance with second embodiments above. In any one or more kits of fifth embodiments, the second kit composition further includes a beneficiating agent in accordance with second embodiments herein, that is, one or more hydroxy fatty acids, one or more hydroxy fatty acid salts, or any combination thereof are combined with the collector in the collector composition. In some such second kit compositions, the weight proportion of the collector to the beneficiating agent is between 100:1 and 1:100, for example 90:1 to 1:100, or 80:1 to 1:100, or 70:1 to 1:100, or 60:1 to 1:100, or 50:1 to 1:100, or 40:1 to 1:100, or 30:1 to 1:100, or 20:1 to 1:100, or 10:1 to 1:100, or 1:1 to 1:100, or 100:1 to 1:90, or 100:1 to 1:80, or 100:1 to 1:70, or 100:1 to 1:60, or 100:1 to 1:50, or 100:1 to 1:40, or 100:1 to 1:30, or 100:1 to 1:20, or 100:1 to 1:10, or 100:1 to 1:1, or 10:1 to 1:10, or 2:1 to 1:1, or 1:1 to 1:2, or 5:1 to 1:1, or 1:1 to 1:5, or 10:1 to 1:1, or 1:1 to 1:10, or 10:1 to 1:10, or 20:1 to 1:1, or 1:1 to 20:1, or 20:1 to 1:20, or 50:1 to 1:1, or 1:1 to 50:1, or 50:1 to 1:50, or 100:1 to 1:1, or 1:1 to 1:100, or about 1:1, or about 1:2, or about 1:3, or about 1:4, or about 1:5, or about 1:6, or about 1:7, or about 1:8, or about 1:9, or about 1:10, or about 1:20, or about 1:30, or about 1:40, or about 1:50, or about 1:60, or about 1:70, or about 1:80, or about 1:90, or about 1:100, or about 2:1, or about 3:1, or about 4:1, or about 5:1, or about 6:1, or about 7:1, or about 8:1, or about 9:1, or about 10:1, or about 20:1, or about 30:1, or about 40:1, or about 50:1, or about 60:1, or about 70:1, or about 80:1, or about 90:1, or about 100:1 by weight. Accordingly, in any one or more kits of fifth embodiments, the second kit composition comprises, consists essentially of, or consists of a combination of a collector and a beneficiating agent in accordance with second embodiments above. Further, in any one or more kits of fifth embodiments, the second kit composition further comprises a solvent, such as any one or more of the solvents disclosed in first embodiments herein. Where both the first and second kit compositions include a solvent, the solvent of the second kit composition is the same as or different from the solvent of the first kit composition.

In any one or more kits of fifth embodiments herein, a froth flotation processing kit comprises, consists essentially of, or consists of a first kit composition that is a modifier composition in accordance with any one of first embodiments herein; a second kit composition that is a collector composition comprising, consisting essentially of, or consisting of one or more sulfonated fatty acids, one or more sulfonated fatty acid salts, or any combination thereof; and a third kit composition that is a beneficiating agent composition comprising, consisting essentially of, or consisting of one or more hydroxy fatty acids, one or more one or more hydroxy fatty acids, one or more hydroxy fatty acid salts, or any combination thereof. In some such fifth embodiments, the third kit composition further includes a solvent selected from any of the solvents disclosed in first embodiments herein, wherein the solvent of the third kit composition is the same as or different from the solvent of the first kit composition and/or the solvent of the second kit composition. That is, any one or more of first, second, or third kit compositions of kits of fifth embodiments herein can include a solvent, further wherein the solvent for each of the kit compositions is individually selected from the solvents of first embodiments herein.

In any one or more kits of fifth embodiments herein, a froth flotation processing kit comprises, consists essentially of, or consists of a first kit composition disposed within a first containment; and a second kit composition disposed within a second containment. In any one or more kits of fifth embodiments, a froth flotation processing kit further includes a third kit composition disposed within a third containment. In any one or more kits of fifth embodiments, any one or more of first, second, or third containments are formed from glass, metal, or plastic, or any combination of these. In any one or more kits of fifth embodiments, a froth flotation processing kit is provided in a package, bag, box, cart, case, or combination of two or more thereof that is suitable for transporting the froth flotation processing kit from a manufacturing location or a storage location to a location proximal to one or more froth flotation cells used for flotation of phosphate ore, lithium ore, or iron ore. In any one or more kit containments of fifth embodiments, a froth flotation processing kit containment is adapted and configured to connect directly to one or more pipes or tubes to establish a sealed fluid connection for directing a kit composition from within the kit containment into a froth flotation cell. In any one or more kits of fifth embodiments herein, the rate of addition and timing of batch addition of one or more kit compositions to a froth flotation cell is suitably controlled by an operator of the froth flotation cell.

### EXPERIMENTAL SECTION

### Example 1

Collector formulation and modifier formulations were formed by admixing the components of Table 1 in the indicated amounts. The admixed formulations were observed to be stable and homogeneous solutions or emulsions, that is, each of the formulations was allowed to sit on a laboratory bench for a period of 24 months, and no phase visible signs of separation, gelling, or other instability was observed.

TABLE 1
Components of collector and modifier formulations

| Formu- | Formu- | | |
|---|---|---|---|
| lation | lation | | Component |
| No. | Type | Formulation Component | Amount, % |
| 1 | Collector | saponified C8-C18 fatty acid salts | 24.54 |
| | | sodium ricinoleate | 3.78 |
| | | sulfonated oleic acid potassium salt | 14.27 |
| | | deionized water | 57.41 |
| 2 | Collector | saponified C8-C18 fatty acid salts | 22.61 |
| | | sodium ricinoleate | 3.25 |
| | | sulfonated oleic acid potassium salt | 9.69 |
| | | deionized water | 58.94 |
| | | C11-C14 fatty alcohol alkoxylated | 5.51 |
| | | with 5-15 mol EO and 1-10 mol PO | |
| 3 | Modifier | C16-C18 fatty alcohol alkoxylated | 60 |
| | | with 5-15 mol EO and 5-15 mol PO | |
| | | C11-C14 fatty alcohol alkoxylated | 40 |
| | | with 5-15 mol EO and 1-10 mol PO | |
| 4 | Modifier | C16 to C18 fatty acid triglycerides | 50 |
| | | C11-C14 fatty alcohol alkoxylated | 10 |
| | | with 5-15 mol EO and 1-10 mol PO | |
| | | C16-C18 fatty alcohol alkoxylated | 20 |
| | | with 5-15 mol EO and 5-15 mol PO | |
| | | Distillates (petroleum), straight-run | 20 |
| | | middle | |

### Examples 2 and 3

The collector formulations and modifier formulation of Example 1 were subjected to reverse froth flotation testing using the following general procedure.

The reverse froth flotation tests are conducted in a 1 liter flotation cell using a standard laboratory flotation machine equipped with mechanical stirrer. For each test, a slurry of phosphate ore is made by dispersing a 255 g charge of an air-dried, split, and bagged phosphate ore in 750 mL tap water within the flotation cell, while stirring the cell contents at 500 rpm; and then continuously stirring at 500 rpm throughout the following steps: allow the cell contents to be stirred for 1 minute; then add phosphoric acid solution (50-52% P₂05) to the cell in an amount sufficient to adjust the pH of the cell contents to a value between 5 and 5.2; then allow the cell contents to be stirred for 1 minute; then add a collector composition of Table 1 to the cell in a selected amount; then allow the cell contents to be stirred for 1 minute; then add a modifier composition of Table 1, if any, to the cell in a selected amount; then, if a modifier composition was added, allow the cell contents to be stirred for 30 seconds.

Upon completing the foregoing steps, the rate of stirring is increased to 750 rpm, and air is sparged through the contents of the cell at a rate of 5 liters/minute for 3 minutes. Any excess foam appearing in the test cell is noted during the sparging; observations regarding excess foaming are noted following Table 2.

Then a gangue comprising calcite and/or dolomite is floated from the slurry and removed as tailings; and a concentrated phosphate ore comprising apatite remains in the slurry as concentrate. Both concentrate and tailings are filtered, dried, weighed, and the concentrate materials analyzed for P₂O₅ grade and % recovery. Results of the analysis are shown in Table 2.

TABLE 2
Results and observations of reverse froth flotation
testing of Formulations 1-4 of Table 1.

| | | Grade P₂O₅, % | | Recovery P₂O₅, % | |
|---|---|---|---|---|---|
| | Formulation added, | in | in | in | in |
| Example No. | amount | concentrate | tailings | concentrate | tailings |
| 2 | Collector 1, 1.2 mL | 26.56 | 4.4 | 87.67 | 12.33 |
| | Modifier 3, 0.6 mL | | | | |
| 3 | Collector 2, 1.2 mL | 28.24 | 3.51 | 89.93 | 10.07 |
| | Modifier 4, 0.36 mL | | | | |

It was further observed during the sparging that a small amount of excess foam was generated in the test of Example 2, while no excess foam was generated in the test of Example 3.

It can be seen from the results in Table 2 that Example 3, employing a modifier formulation in accordance with the modifier compositions of first embodiments herein, and embodying a sparge composition that accords with the sparge compositions of second embodiments herein, and tested using reverse froth flotation in accordance with the methods of third embodiments herein, obtains 1.68% greater grade of P₂O₅ in the concentrate, and 0.89% lower grade of P₂O₅ in the tailings compared to Example 2. Example 2 employs a modifier formulation that includes an alkoxylated fatty alcohol, but excludes a fatty acid triglyceride. Accordingly, the Modifier 3 formulation is not a modifier composition in accord with first embodiments herein, and the sparge composition of Example 2 is not a sparge composition in accord with any of second embodiments herein.

It can further be seen from the results in Table 2 that Example 3 obtains 2.26% greater yield (recovery) of P₂O₅ in the concentrate, and 2.26% less P₂O₅ in the tailings compared to Example 2. Accordingly, in Example 3, improvements in phosphate grade correlate with improvements in phosphate recovery, which is unexpected and counterintuitive to the understanding of one of skill in the art of froth flotation.

What is claimed is:

1. A modifier composition comprising a mixture of one or more fatty acid triglycerides with one or more alkoxylated fatty alcohols.

2. The modifier composition of claim 1 further comprising a solvent, the solvent optionally comprising water, wherein the solvent is 0.1 wt % to 99 wt % of the modifier composition.

3. The modifier composition of claim 1 wherein the weight proportion of the one or more fatty acid triglycerides to the one or more alkoxylated fatty alcohols in the mixture is between 100:1 and 1:100.

4. The modifier composition of claim 1 wherein each of the one or more alkoxylated fatty alcohols independently has a structure according to the formula 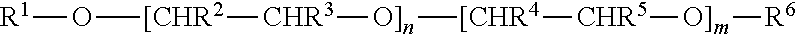
wherein
R¹ is a linear, branched, or alicyclic C6-C30 saturated or unsaturated moiety,
R², R³, R⁴, R⁵ and R⁶ are independently selected from H or a C1-C5 linear or branched alkyl moiety,
n is 0 or an integer between 1 and 100,
m is 0 or an integer between 1 and 100, and
the sum of n+m is at least 2.

5. The modifier composition of claim 4 wherein the one or more alkoxylated fatty alcohols comprises a first alkoxylated fatty alcohol comprising R¹ that is a linear or branched C16-C20 moiety; and a second alkoxylated fatty alcohol comprising R¹ that is a linear or branched C6-C14 moiety.

6. The modifier composition of claim 5 wherein the first alkoxylated fatty alcohol comprises R² R³, and R⁴ each of which is H, R⁵ that is CH₃, n that is between 1 and 35, and m that is between 1 and 35; and
the second alkoxylated fatty alcohol comprises R² R³, and R⁴ each of which is H, R⁵ that is CH₃, n that is between 1 and 35, and m that is between 1 and 35.

7. The modifier composition of claim 1 wherein each of the one or more fatty acid triglycerides independently has a structure according to the formula 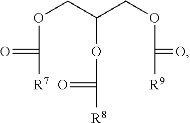
wherein R⁷, R⁸, and R⁹ are independently selected from saturated or unsaturated C6-C30 linear, branched, or alicyclic moieties.

8. The modifier composition of claim 7 wherein one or more of R⁷, R⁸, and R⁹ are C10-C20 moieties, and/or wherein one or more of R⁷, R⁸, and R⁹ are unsaturated.

9. The modifier composition of claim 1 wherein each of the one or more fatty acid triglycerides are derived from a plant source, optionally wherein the plant source is selected from: cotton, flax, grape, hemp, safflower, olive, palm, peanut, rice, avocado, canola, coconut, corn, sesame, soybean, sunflower, walnut, or any combination thereof.

10. A sparge composition comprising a mixture of:
(i) a medium comprising water;
(ii) a mineral ore comprising a beneficiary and a gangue;
(iii) a collector; and
(iv) a modifier composition in accordance with claim 1.

11. The sparge composition of claim 10 wherein the mineral ore is a phosphate ore, a lithium ore, or an iron ore, wherein the phosphate ore comprises an apatite beneficiary and a gangue comprising calcite, dolomite, a silicate, silica, a seashell or seashell portion, or any combination thereof.

12. The sparge composition of claim 10 further comprising a pH adjustment agent selected from phosphoric acid, sulfuric acid, hydrochloric acid, acetic acid, citric acid, a polymeric acid, or any combination thereof; and/or sodium carbonate, potassium carbonate, sodium bicarbonate, potassium bicarbonate, sodium hydroxide, potassium hydroxide, or any combination thereof.

13. The sparge composition of claim 10 further comprising a beneficiation agent, wherein the beneficiation agent optionally comprises ricinoleic acid, a salt of ricinoleic acid, 12-hydroxystearic acid, a salt of 12-hydroxystearic acid, 9,10-dihydroxyoctadecanoic acid, a salt of 9,10-dihydroxyoctadecanoic acid, 9,10,18-trihydroxyoctadecanoic acid, a salt of 9,10,18-trihydroxyoctadecanoic acid, lesquerolic acid, a salt of lesquerolic acid, 15-hydroxyhexadecanoic acid, a salt of 15-hydroxyhexadecanoic acid, isoricinoleic acid, a salt of isoricinoleic acid, densipolic acid, a salt of densipolic acid, 14-hydroxy-eicosa-cis-11-cis-17-dienoic acid, a salt of 14-hydroxy-eicosa-cis-11-cis-17-dienoic acid, 2-hydroxyoleic acid, a salt of 2-hydroxyoleic acid, 2-hydroxylinoleic acid, a salt of 2-hydroxylinoleic acid, 18-hydroxystearic acid, a salt of 18-hydroxylinoleic acid, 15-hydroxylinoleic acid, a salt of 15-hydroxylinoleic acid, or any combination thereof.

14. The sparge composition of claim 10 wherein the collector comprises sulfonated oleic acid, a sulfonated oleic acid salt, sulfonated linoleic acid, a sulfonated linoleic acid salt, sulfonated linolenic acid, a sulfonated linolenic acid salt, sulfonated ricinoleic acid, a sulfonated ricinoleic acid salt, sulfonated palmitoleic acid, a sulfonated palmitoleic acid salt, sulfonated 11-eicosenoic acid, a sulfonated 11-eicosenoic acid salt, sulfonated erucic acid, a sulfonated erucic acid salt, sulfonated nervonic acid, a sulfonated nervonic acid salt, or any combination thereof.

15. The sparge composition of claim 10 further comprising one or more emulsifying surfactants, one or more additional collectors, one or more depressants, one or more activators, one or more frothing agents, or any combination thereof.

16. The sparge composition of claim 10 further comprising a beneficiating agent comprising one or more hydroxy fatty acids, one or more hydroxy fatty acid salts, or any combination thereof, wherein the collector comprises one or more sulfonated fatty acids, one or more sulfonated fatty acid salts, or any combination thereof.

17. The sparge composition of claim 10, further comprising a pH adjusting agent and having a pH of about 2.5 to about 7.

18. The sparge composition of claim 10, further comprising a pH adjusting agent and having a pH of about 7 to about 12.

19. A method of froth flotation comprising sparging the sparge composition of claim 10 in a flotation cell to yield a sparged slurry comprising an overflow and an underflow.

20. The method of claim 19 further comprising collecting the overflow, or the underflow, or both the overflow and the underflow.

21. A froth flotation processing kit comprising a modifier composition of claim 1 disposed within a first containment; and a collector composition disposed within a second containment, the collector composition comprising one or more sulfonated fatty acids, one or more sulfonated fatty acid salts, or any combination thereof.
